(19) United States
(12) Patent Application Publication
(10) Pub. No.: US 2026/0070443 A1
(43) Pub. Date: Mar. 12, 2026

(54) CHARGING SYSTEM

(71) Applicant: LG ELECTRONICS INC., Seoul (KR)

(72) Inventors: Taehee KWAK, Seoul (KR); Jiho LEE, Seoul (KR)

(73) Assignee: LG ELECTRONICS INC., Seoul (KR)

(21) Appl. No.: 19/107,449

(22) PCT Filed: Dec. 6, 2022
(86) PCT No.: PCT/KR2022/019680

§ 371 Date: Feb. 27, 2025

(51) Int. Cl. B60L 53/302; B60L 53/18; B60L 53/30; B60L 53/67

(52) U.S. Cl. CPC B60L 53/302; B60L 53/18; B60L 53/305; B60L 53/67

(57) ABSTRACT

A charging system according to an embodiment comprises; a plurality of chargers to which a charging cable having cable channels formed inside is connected; a cooler that cools a cooling fluid; a cooling fluid inlet channel connected to the cooler and a plurality of charging cables and guiding the cooling fluid to the plurality of charging cables; a cooling fluid outlet channel connected to the plurality of charging cables and guiding the cooling fluid to the cooler; and a plurality of valves installed in at least one of the cooling fluid inlet channel and the cooling fluid outlet channel; and a controller that controls the plurality of valves according to charging information of the plurality of chargers.

### TECHNICAL FIELD

The present disclosure relates to a charging system.

### BACKGROUND ART

The development of electric vehicles has created an increased need for charging devices that deliver power.

The higher the current in any conductor, the more heat is generated. As a result, the conductors between the charging device and the vehicle have become larger in size to accommodate higher inrush currents.

An example of a charging system capable of charging an electric vehicle is an electric vehicle cooling system disclosed in U.S. Patent Publication No. U.S. Pat. No. 11,180,044 B2 (patented on Nov. 23, 2021), wherein the electric vehicle cooling system comprises a vehicle portion and a charging portion, the charging portion comprises a cable connected to an adapter connected to an electric vehicle, a base connected to the cable, and a chiller connected to the base and configured to exchange heat between coolant and refrigerant, and a charging line for charging the electric vehicle, an inlet channel through which coolant supplied from the electric vehicle flows to the base, and an outlet channel through which coolant flowing from the base flows to be supplied to the electric vehicle are formed inside the cable.

### DISCLOSURE

### Technical Problem

The charging system according to the conventional technology cools the charging unit using the cooling system of the vehicle unit, so there is a problem that it is difficult to smoothly respond to the charging method such as slow charging or rapid charging of the charging unit.

Since the charging system according to the conventional technology flows coolant to cool the battery of the vehicle unit to the charging unit, the cooling system may have insufficient capacity, so that the temperature of the battery may rise and the charging unit may not be charged smoothly.

An abject of the present embodiment is to provide a charging system in which a cooler can respond to the charging conditions of a plurality of chargers or charging conditions of a plurality of charging cables, and perform efficient cooling even when the plurality of chargers or the plurality of charging cables are charging simultaneously.

### Technical Solution

One example of a charging system comprises a plurality of chargers connected to charging cables having cable path formed inside of the charging cable; a cooler for cooling a cooling fluid; a cooling fluid inlet channel connected to the cooler and the plurality of charging cables and guiding the cooling fluid to the plurality of charging cables; a cooling fluid outlet channel connected to the plurality of charging cables and the cooler and guiding the cooling fluid to the cooler; and a plurality of valves installed in at least one of the cooling fluid inlet channel and the cooling fluid outlet channel; and a controller configured to control the plurality of valves according to charging information of the plurality of chargers.

The controller may receive charging information from the plurality of chargers and may determine a cooling capacity of the cooler according to a received charging information.

One example of the valve may be an on-off valve, and the controller may control opening and closing of the on-off valve.

The other example of valve may be a flow control valve, and the controller may control a flow rate of the flow control valve.

The cooling fluid may be a coolant.

The cooler in one example of the charging system further may comprise a radiator that radiates the coolant; and a pump that pumps the coolant.

One example of the charging system may further comprise a heat dissipation fan that blows air to the radiator, and the controller may vary a RPM of the heat dissipation fan according to the charging information of the plurality of chargers.

The controller may adjust a rotation speed of the pump in multiple stages according to the charging information of the plurality of chargers.

The cooler in another example of the charging system may comprise a compressor a condenser, an expansion device, and an evaporator through which refrigerant circulates, the evaporator may have a refrigerant path through which the refrigerant passes, a coolant path through which coolant that exchanges heat with the refrigerant passes, each of the cooling fluid inlet channel and the cooling fluid outlet channel may be connected to the coolant path, and a pump for pumping coolant may be installed in at least one of the cooling fluid inlet channel and the cooling fluid outlet channel.

The controller may control an operating capacity of the compressor in proportion to a charging voltage of a charger being charging among a plurality of chargers.

The cooler may further comprise a condensing fan that blows air to the condenser, and the controller may control a RPM of the condensing fan in proportion to the charging voltage of a charger being charged among a plurality of chargers.

The other example of a charging system comprising: a charger having a plurality of charging cables connected to the charger, each of the plurality of charging cables having a cable path formed inside the charging cable; a cooler for cooling a cooling fluid; a cooling fluid inlet channel connected to the cooler and the plurality of charging cables and guiding the cooling fluid to the plurality of charging cables; a cooling fluid outlet channel connected to the plurality of charging cables and the cooler and guiding the cooling fluid to the cooler; a plurality of valves installed in at least one of the cooling fluid inlet channel and the cooling fluid outlet channel; and a controller for controlling the plurality of valves according to charging information of the plurality of charging cables.

The controller may receive charging information from the charger and may determine a cooling capacity of the cooler according to a received charging information.

The cooling fluid may be a coolant.

One example of the cooler may further comprise a radiator for dissipating the coolant; and a pump for pumping the coolant.

The other example of the charging system may further comprise a heat dissipation fan for blowing air to the radiator.

The controller may vary a RPM of the heat dissipation fan according to the charging information of the plurality of charging cables.

The controller may adjust a rotation speed of the pump in multiple stages according to the charging information of the plurality of charging cables.

Another example of the cooler may comprise a compressor, a condenser, an expansion device, and an evaporator through which refrigerant circulates, the evaporator may have a refrigerant path through which the refrigerant passes, and a coolant path through which the coolant that exchanges heat with the refrigerant passes, each of the cooling fluid inlet channel and the cooling fluid outlet channel may be connected to the coolant path, a pump for pumping the coolant may be installed in at least one of the cooling fluid inlet channel and the cooling fluid outlet channel.

The controller may control an operating capacity of the compressor in proportion to a charging voltage of a charging cable being charging among a plurality of charging cables.

The other example of the cooler may further comprise a condensing fan that blows air to the condenser, and the controller may control a RPM of the condensing fan in proportion to a charging voltage of a charging cable being charging among a plurality of charging cables.

The charging cable may comprise a communication line, a charging line having an inner channel formed inside that communicates with the cooling fluid inlet channel; and an outer tube surrounding the charging line and the communication line, and an outer channel may be formed between the charging line, the communication line, and the outer tube that communicates with the cooling fluid outlet channel.

### Advantageous Effect

According to the present embodiment, a single cooler can cool a plurality of charging cables simultaneously, which can increase the space utilization of the charging station.

In addition, the flow rate or temperature of the cooling fluid flowing through some or all of the plurality of charging cables can be controlled according to the charging information of the multiple charging cables, so that more efficient cooling operation is possible according to the charging load of the plurality of cables.

### DESCRIPTION OF DRAWINGS

FIG. 1 is a view illustrating an example of a charging system according to the present embodiment.

FIG. 2 is a view illustrating an example of a charging cable according to the present embodiment.

FIG. 3 is a cross-sectional view taken along line A-A′ of FIG. 2.

FIG. 4 is a perspective view illustrating an example of a radiator illustrated in FIG. 1.

FIG. 5 is a control block view of an example of a charging system according to the present embodiment.

FIG. 6 is a view illustrating another example of a charging system according to the present embodiment.

FIG. 7 is a view illustrating an example of an evaporator illustrated in FIG. 6.

FIG. 8 is a control block view of another example of a charging system according to the present embodiment.

FIG. 9 is a view illustrating another example of a charging system according to the present embodiment.

FIG. 10 is a control block view of another example of a charging system according to the present embodiment.

### BEST MODE

Hereinafter, specific embodiments of the present invention will be described in detail with reference to the drawings.

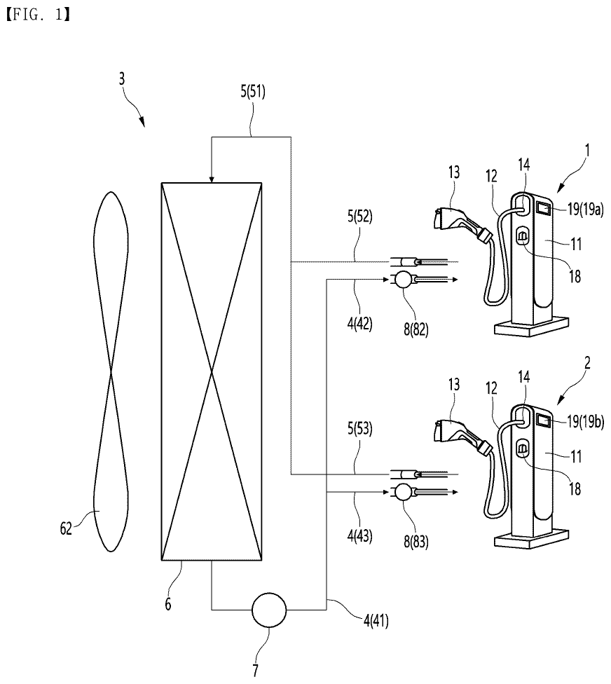

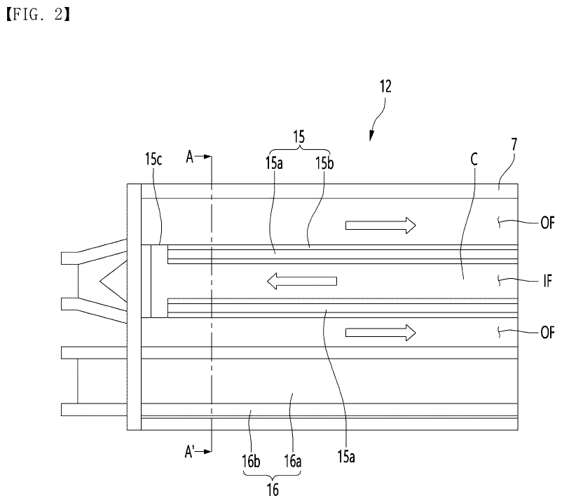

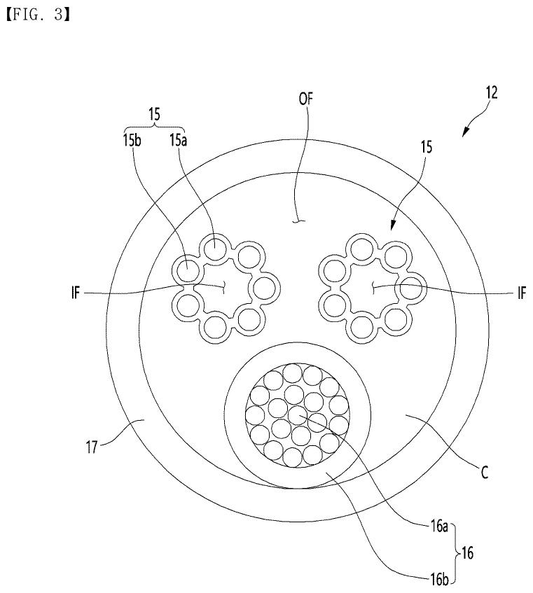

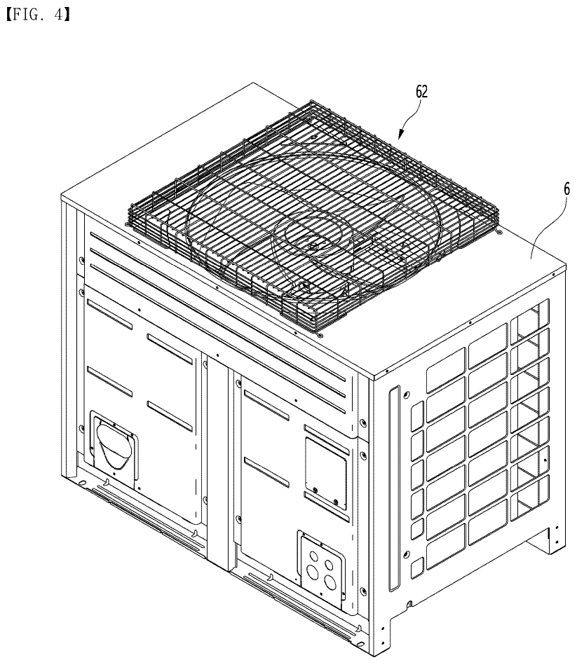

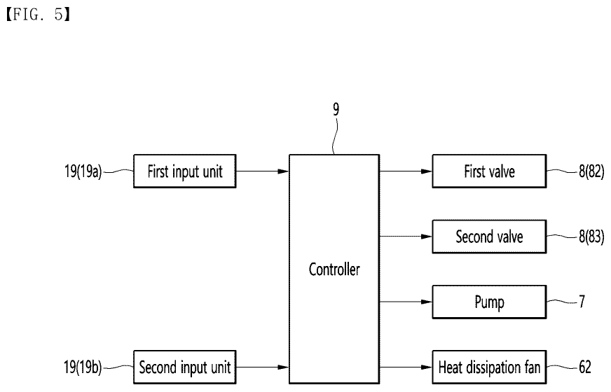

FIG. 1 is a view illustrating an example of a charging system according to the present embodiment, FIG. 2 is a view illustrating an example of a charging cable according to the present embodiment, FIG. 3 is a cross-sectional view taken along line A-A′ of FIG. 2, FIG. 4 is a perspective view illustrating an example of a radiator illustrated in FIG. 1, FIG. 5 is a control block view of an example of a charging system according to the present embodiment.

The charging system comprises a plurality of chargers 1 and 2, as shown in FIG. 1, and each of the plurality of chargers 1 and 2 may charge an electric vehicle. The charging system may comprise a multi-port charger that may charge a plurality of electric vehicles together.

The plurality of chargers 1 and 2 may have the same configuration, and for the convenience of explanation, the same configurations will be described below using the same drawing reference numerals.

Each of the plurality of chargers 1 and 2 may comprise a charging cable unit 11 forming an outer appearance, as shown in FIG. 1, and a charging cable 12 connected to the charging cable unit 11.

A connector (adapter) 13 connected to an electric vehicle may be disposed at one end of the charging cable 12, and a connection terminal 14 connected to the charging cable unit 11 may be disposed at the other end of the charging cable 12.

The connection terminal 14 may be electrically connected to a power unit disposed in the charging cable unit 11, and when current is applied from the power unit, the charging cable 1 may charge the battery of the electric vehicle to which the connector 13 is connected.

The charging cable unit 11 or the connector 13 may comprise a switch that controls the current applied to the electric vehicle, and when the switch is on, the charging cable 12 may charge the battery of the electric vehicle, and when the switch is off, the charging cable 12 may not charge the battery of the electric vehicle.

The charging cable 12 may comprise a charging line 15, a communication line 16, and an outer tube 17, as shown in FIGS. 2 and 3, and the outer tube 17 may surround the charging line 15 and the communication line 16.

A cable path through which a cooling fluid passes may be formed inside the charging cable 12.

The charging line 15 may be provided in plurality inside the outer tube 17.

The charging line 15 may comprise at least one charging conductor 15a and an insulating body 15b.

The insulating body 15b may be an electrically insulator, and the insulating body 15b may be a charging outer shell capable of insulating at least one charging conductor 15a. The insulating body 15b may be a heat transfer member capable of transferring the heat of the charging conductor 15a to the cooling fluid C.

An inner flow path IF may be formed inside the charging line 15, and the inner flow path IF may be connected to a cooling fluid inlet channel 4, shown in FIG. 1 described below.

The insulating body 15b may comprise a hollow tube portion, and the tube portion may comprise an outer circumference and an inner circumference.

The outer circumference of the insulating body 15b may be spaced apart from the inner circumference of the outer tube 17.

The inner circumference of the insulating body 15b may form an inner flow path IF. The inner flow path IF may be formed on the inner of the inner circumference of the insulating body 15b. The inner flow path IF may be formed long in the length direction of the insulating body 15b inside the insulating body 15b.

The insulating body 15b may have a cooling fluid recovery hole 15c, shown in FIG. 2 formed in a portion that does not surround the charging conductor 15a.

The cooling fluid of the inner flow path IF may pass through the cooling fluid recovery hole 15c and flow into the outer flow path OF.

The communication line 16 may comprise a plurality of communication conductors 16a and a communication outer shell 16b surrounding the plurality of communication conductors 16a.

The outer tube 17 may be separated from the charging line 15 and the communication line 16. An outer flow path OF may be formed inside the outer tube 17. The outer flow path OF may be formed between the charging line 15, the communication line 16, and the outer tube 17.

The outer flow path OF may be connected to a cooling fluid outlet channel 5, shown in FIG. 1 described below.

The cable flow path inside the charging cable 12 may comprise an inner flow path IF, a cooling fluid recovery hole 15c, and an outer flow path OF.

The inner flow path IF may form an inlet of the cable flow path, and the outer flow path OF may form an outlet of the cable flow path.

Meanwhile, as illustrated in FIG. 1, a display 18 capable of checking charging information may be disposed in the charging cable unit 11.

The charging cable unit 11 may be provided with an input unit 19 that allows an user to input various commands related to charging of the electric vehicle. The input unit 19 may be provided separately from the display 18 or may be integrated with the display 18.

As shown in FIG. 1, the charging system may comprise a cooler 3 capable of cooling the charging cable unit 11 or charging cable 12 of each of the plurality of chargers 1 and 2.

The number of coolers 3 is less than the number of chargers 1 and 2, and it will be described below that one cooler 3 may cool all of the charging cables 12 of the plurality of chargers 1 and 2.

The cooler 3 may cool the charging cable 12 by flowing a cooling fluid into the cable path IF, OF inside the charging cable 12.

An example of the cooling fluid may be a coolant C such as water, antifreeze, or glycerin.

The other example of a cooling fluid may be a refrigerant that may change phase (liquefy or vaporize) depending on a change in temperature.

Although the present embodiment describes that the cooling fluid is a coolant C, shown in FIGS. 2 and 3, it is to be understood that the cooling fluid is not limited to the coolant C.

As shown in FIG. 1, the cooler 3 may be connected to a charging cable 12 and a cooling fluid inlet channel 4, and may be connected to a charging cable 12 and a cooling fluid outlet channel 5.

The cooler 3 may be placed outside of the charger 1 and 2.

An example of the cooler 3 may comprise a radiator 6.

A coolant passage through which coolant C passes may be formed in the radiator 6. The radiator 6 may be an air-cooled radiator that dissipates coolant C by air cooling. The charging system may further comprise a heat sink fan 62 that blows air e.g., outdoor air around the radiator 6 to the radiator 6. An example of the heat sink 62 may be disposed on the upper side of the radiator 6, as shown in FIG. 2. The heat sink fan 62 may comprise a fan and a motor. An example of the heat sink fan 62 may be an inverter fan that may vary the RPM of the fan.

The cooling fluid inlet channel 4 may be connected to one end i.e., the outlet of the coolant passage of the radiator 6. The cooling fluid inlet channel 4 may guide the coolant C of the radiator 6 to the cable path IF, OF of the charging cable 12.

The cooling fluid outlet channel 5 may be connected to the other end i.e., the inlet of the cooling fluid path of the radiator 6. The cooling fluid outlet channel 5 may guide the coolant C that has passed through the cable path IF, OF of the charging cable 12 to the radiator 6.

The cooler 3 may further comprise a pump 7 that may pump the coolant C.

The pump 7 may be configured as a constant-speed pump that is turned on/off, or a variable-capacity pump (or variable-speed pump) which rotation speed is variable.

The pump 7 may be installed in at least one of the cooling fluid inlet channel 4 and the cooling fluid outlet channel 5. If the pump 7 is installed with a cooling fluid inlet channel 4, the cooling fluid inlet channel 4 may comprise a pump inlet channel connecting the radiator 6 and the pump 7, and a pump outlet channel connecting the pump 7 and the charging cable 12.

The charging system may further comprise a valve 8.

The valve 8 may supply or block the coolant C cooled i.e., heat-radiated in the cooler 3 to the charging cables 12 of the plurality of chargers 1 and 2. The valve 8 may control the flow rate of the coolant C supplied to the charging cables 12 of the plurality of chargers 1 and 2.

The valve 8 may be installed in at least one of the cooling fluid inlet channel 4 and the cooling fluid outlet channel 5.

An example of a valve 8 may be installed in a cooling fluid inlet channel 4, and the cooling fluid inlet channel 4 may comprise a valve inlet channel connecting the pump 7 and the valve 8, and a valve outlet channel connecting the valve 8 and the air cable 12.

If both the pump 7 and the valve 8 are installed in the cooling fluid inlet channel 4, the pump outlet channel may comprise a valve inlet channel and a valve outlet channel. That is, when the pump 7 and the valve 8 are installed in the cooling fluid inlet channel 4, the cooling fluid inlet channel 4 may comprise a pump inlet channel, a valve inlet channel, and a valve outlet channel.

Since the charging system comprises a plurality of chargers 1 and 2, a plurality of valves 8 may be provided. The valve 8 may be provided for each charging cable 12 of each charger 1 and 2. The valve 8 may correspond 1:1 to the charging cable 12 of the charger 1 and 2.

The cooling fluid inlet channel 4 may comprise a common inlet channel 41 and a plurality of branch inlet channels 42 and 43 connecting the common inlet channel 41 and the charging cables 12 of the plurality of chargers 1 and 2.

The common inlet channel 41 may be connected to the other end (i.e., the outlet) of the coolant flow path of the radiator 6.

The plurality of branch inlet channels 42 and 43 may be branched from the common inlet channel 41.

If the cooling fluid inlet channel 4 comprises a common inlet channel 41 and a plurality of branch inlet channels 42 and 43, the pump 7 may be installed in the common inlet channel 41, and the valve 8 may be installed in each of the plurality of branch inlet channels 42 and 43.

The cooling fluid outlet channel 5 may comprise a common outlet channel 51 and a plurality of combined outlet channels 52 and 53 connecting the common outlet channel 51 and the charging cables 12 of the plurality of chargers 1 and 2.

The common outlet channel 51 may be connected to one end (i.e., the inlet) of the coolant flow path of the radiator 6.

The plurality of combined outlet channels 52 and 53 may be combined to the common outlet panel 51.

The valve 8 may be provided for each of the plurality of chargers 1 and 2, and the charging system may supply coolant to any one of the plurality of chargers 1 and 2 or to all of the plurality of chargers 1 and 2.

The charging system may supply coolant only to the chargers in charging operation, and the chargers in charging operation may be cooled more quickly.

For example, if only one charger 1 among the plurality of chargers 1 and 2 is charging and another charger 2 among the plurality of chargers 1 and 2 is in the charging stop state, the charging system may flow coolant C only to the charging cable 12 of the charger 1 that is charging and may not supply coolant to the charger 2 that is in the charging stop state.

For the other example, if one charger 1 among the plurality of chargers 1 and 2 is in the rapid charging state and another charger 2 among the plurality of chargers 1 and 2 is in the slow charging state, the charging system may flow a large amount of coolant C to the charging cable 12 of the charger 1 that is in the rapid charging state and may flow a small amount of coolant C to the charging cable 12 of the charger 2 that is in the slow charging state. The flow rate of the coolant C flowing through the charging cable 12 of the fast charger 1 may be greater than the flow rate of the coolant C flowing through the charging cable 12 of the slow charger 2.

Hereinafter, for convenience of explanation, the plurality of chargers 1 and 2 are described as comprising the first charger 1 and the second charger 2, but of course, the number of chargers is not limited.

The plurality of branch inlet channels 42 and 43 may comprise a common inlet channel 41, a first inlet channel 42 between the charging cable 12 of the first charger 1, and a second inlet channel 43 between the common inlet channel 41 and the charging cable 12 of the second charger 2.

The plurality of combined outlet channels 52 and 53 may comprise a first outlet channel 52 between the charging cable 12 of the first charger 1 and the common outlet channel 51, and a second outlet channel 53 between the charging cable 12 of the second charger 2 and the common outlet channel 51.

The valve 8 may be disposed for each charging cable 12 of the plurality of chargers 1 and 2, and may be divided into a first valve 82 disposed in the first inlet channel 42 or the first outlet channel 52, and a second valve 83 disposed in the second inlet channel 43 or the second outlet channel 53.

The first valve 82 may be installed in the first inlet channel 42 to control the coolant C flowing into the charging cable 12 of the first charger 1.

The second valve 82 is installed in the second inlet channel 43 and may control the coolant C flowing into the charging cable 12 of the second charger 2.

The charging system may further comprise a controller 9.

A plurality of chargers 1 and 2 and a cooler 3 may be connected via a communication cable, and the cooler 9 may individually control the coolant C flowing into the charging cable 12 of the plurality of chargers 1 in response to the received information.

The controller 9 may control the valves 8; 81 and 82 according to the charging information of the plurality of chargers 1 and 2. The controller 9 may receive charging information from the plurality of chargers 1 and 2 and determine the cooling capacity (i.e., operating amount) of the cooler 3 according to the received charging information.

The charging information may comprise information such as the start of charging, charging method (fast charging/slow charging or rapid charging/low speed charging), charging time, and charging end. The charging information may comprise information on the number of chargers being charging. The charging information may comprise information on fast charging or slow charging of the charger being charging.

The controller 9 may control the pump 7 and the heat dissipation fan 62 according to the charging information of the plurality of chargers 1 and 2.

If the plurality of chargers 1 and 2 are a first charger 1 and a second charger 2, the first charger 1 may comprise a first input unit 19a for inputting an operation command of the first charger 1, and the second charger 2 may comprise a second input unit 19b for inputting an operation command of the second charger 2.

The controller 9 may control the cooler 3 according to the input of the first input unit 19a or the input of the second input unit 19b.

The controller 9 may control the valve 8; 82 and 83 according to the input of the first input unit 19a or the second input unit 19b.

An example of the valve 8; 82 and 83 may be an on-off valve. The controller 9 may control the opening and closing of the on-off valve. The on-off valve may be a solenoid valve, and the controller 9 may control the on and off of the solenoid valve, control the coolant flowing through the charging cable 12 of the first charger 1, and control the coolant flowing through the charging cable 12 of the second charger 2. The first valve 82 and the second valve 83 may be opened and closed independently.

The other example of the valve 8; 82 and 83 may be a flow control valve or capacity control valve. The flow control valve may be a valve capable of controlling the opening, and the opening may be controlled in multiple stages. The controller 9 may control the opening of the flow control valve. If the valve 8 is a flow control valve or capacity control valve, the valve 8 may control the flow rate of the coolant according to the charging capacity of the plurality of chargers 1.

The controller 9 may control the first valve 82 and the second valve 83 to adjust the flow rate of the coolant C flowing through the charging cable 12 of the first charger 1 and to adjust the flow rate of the coolant C flowing through the charging cable 12 of the second charger 2. The first valve 82 and the second valve 83 may adjust the flow rate of the coolant C in proportion to the charging capacity.

The other example of the valve 8 may comprise an on-off valve and a flow rate control valve. The flow rate control valve may be placed before the on-off valve or after the on-off valve in the flow direction of the coolant C. The controller 9 may control the coolant supplied to the charging cable 12 of the first charger 1 or the charging cable 12 of the second charger 2 by opening and closing the opening/closing valve, and may control the flow rate of the coolant supplied to the charging cable 12 of the first charger 1 or the charging cable 12 of the second charger 2 by controlling the opening of the flow rate control valve.

The controller 9 may vary the RPM of the heat dissipation fan 62 according to the charging information of the plurality of chargers 1 and 2. The controller 9 may vary the RPM of the heat dissipation fan 62 according to the charging load, and may control the cooler 3 in response to the charging load and the cooling load.

The controller 9 may adjust the rotation speed of the pump 7 in multi stage according to the charging information of the plurality of chargers 1 and 2. The controller 9 may vary the rotation speed of the pump 7 according to the charging load and control the cooler 3 in response to the charging load and cooling load.

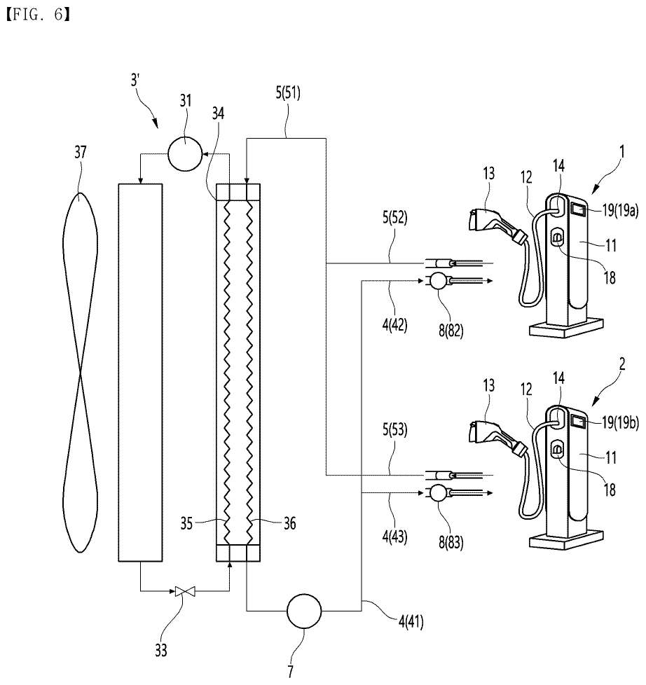

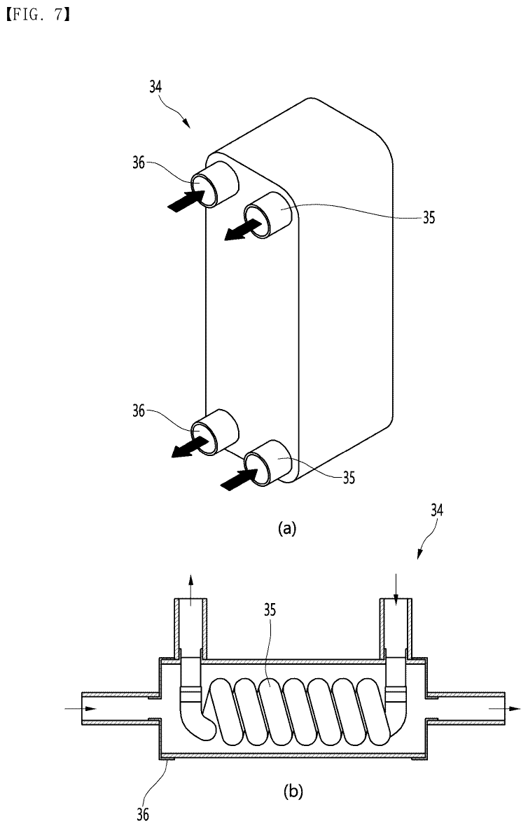

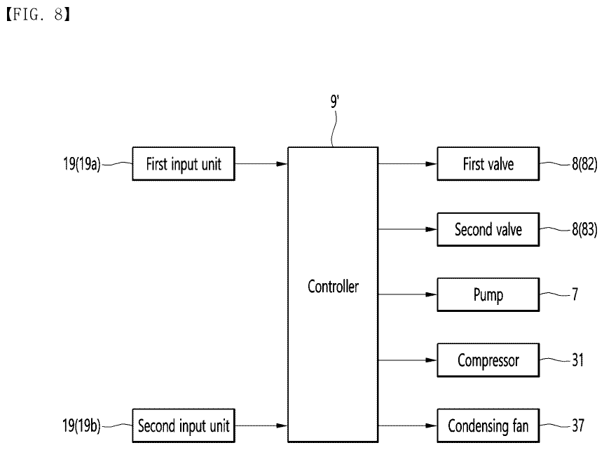

FIG. 6 is a view illustrating another example of a charging system according to the present embodiment, FIG. 7 is a view illustrating an example of an evaporator illustrated in FIG. 6, and FIG. 8 is a control block view of another example of a charging system according to the present embodiment.

Another example of a charging system may comprise a cooler 3′ different from the cooler 3 of the charging system.

The cooler 3′ may comprise a compressor 31, a condenser 32, an expansion device 33, and an evaporator 34.

A compressor discharge pipe may be connected to the compressor 31, and the compressor discharge pipe may be connected to the condenser 32.

The compressor 31 may be a constant-speed compressor with a constant operating capacity or a variable-capacity compressor with a variable operating capacity. When the compressor 31 is a variable-capacity compressor, the capacity of the compressor 31 may be varied according to the operating information of the charger 12 (e.g., rapid charging/low speed charging).

The controller 9′ may control the compression capacity (i.e., operating capacity) of the compressor 31 according to the charging load of the plurality of chargers 1 and 2.

A condenser discharge pipe may be connected to the condenser 32, and the condenser discharge pipe may be connected to the expansion device 33.

The condenser 32 may dissipate the refrigerant in an air-cooled manner. The cooler 3′ may further comprise a condensing fan 37 that blows air to the condenser 32. The condensing fan 37 may blow air around the condenser 32. The condensing fan 37 may comprise a fan and a motor. An example of the condensing fan 37 may be an inverter fan that may vary the RPM of the fan.

The controller 9′ may control the RPM of the condensing fan 37 according to the charging load of the plurality of chargers 1 and 2.

The expansion device 33 may be a capillary tube or an electronic expansion valve such as EEV, EXV, etc.

An evaporator connection pipe may be connected to the expansion device 33, and the evaporator connection pipe may be connected to the evaporator 34.

A compressor suction pipe may be connected to the evaporator 34, and the compressor suction pipe may be connected to the compressor 31.

The evaporator 34 may be formed with a refrigerant passage 35 through which refrigerant passes, and a coolant passage 36 through which coolant C that exchanges heat with the refrigerant passes.

The evaporator 34 may comprise a plate heat exchanger, as shown in a of FIG. 7, or a double-pipe heat exchanger, as shown in b of FIG. 7.

The coolant C of another example of the charging system may be the same as the refrigerant that flows from the condenser 33 to the refrigerant path 35 of the evaporator 34, or may be a different type of refrigerant than the refrigerant that flows from the condenser 33 to the refrigerant path 35 of the evaporator 34.

The refrigerant of the cooler 3′ may circulate through the compressor 31, the condenser 32, the expansion device 33, and the refrigerant path 35 of the evaporator 34.

Each of the cooling fluid inlet channel 4 and the cooling fluid outlet channel 5 may be connected to the coolant path 36, and a pump 7 for pumping the coolant C and a valve 8 for controlling the coolant C may be installed in at least one of the cooling fluid inlet channel 4 and the cooling fluid outlet channel 5.

The controller 9′ may control the operating capacity of the compressor 31 in proportion to the charging voltage of the charger being charging among the plurality of chargers 1 and 2.

The controller 9 may control the RPM of the condensing fan 37 in proportion to the charging voltage of the charger being charging among the plurality of chargers 1 and 2.

The controller 9 may respond to the large capacity of the plurality of chargers 1 and 2 by controlling the evaporation temperature of the evaporator 34 and controlling the plurality of valves 8; 82 and 83.

The controller 9 may determine the charging capacity by whether the valves 8, 82 and 83 are open or closed when charging starts, and may calculate the cooling capacity (i.e., required cooling power) required by the cooler 3′. The controller 9 may determine the priority cooling order of the plurality of charging cables 12, and control the valves 8, 82 and 83, the compressor 31, and the condensing fan 37 accordingly.

In this embodiment, the cooler 3′ comprises a compressor 31, a condenser 32, an expansion mechanism 33, an evaporator 34, and a condensing fan 37, and the controller 9′ controls the operating capacity of the compressor 31 in proportion to the charging voltage of the charger being charged among the plurality of chargers 1 and 2, and the controller 7 controls the RPM of the condensing fan 37 in proportion to the charging voltage of the charger being charged among the plurality of chargers 1 and 2. Other configurations and operations may be the same as or similar to the charging system example of this embodiment, and the same symbols are used to avoid duplicate descriptions, and detailed descriptions thereof are omitted.

That is, the configurations of the charger 12, the charging cable 12, the cooling fluid inlet channel 4, the cooling fluid outlet channel 5, and the valve 8, or the control of the valve 8, may be the same as or similar to the charging system example of this embodiment, and the same symbols are used, and detailed descriptions thereof are omitted.

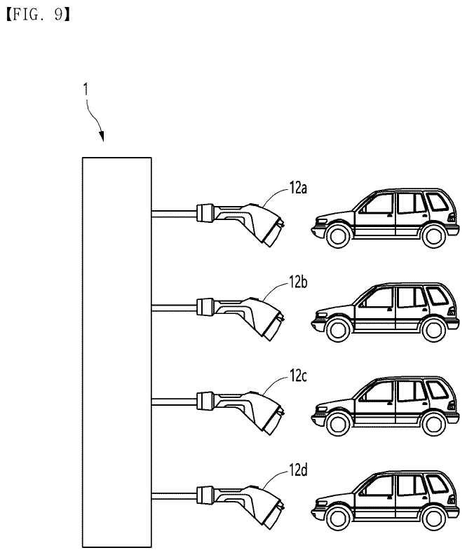

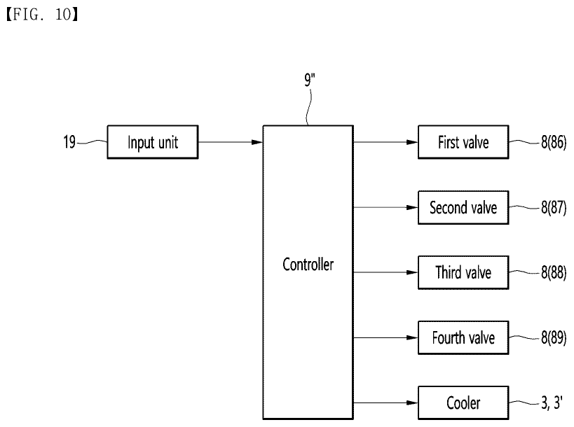

FIG. 9 is a view illustrating another example of a charging system according to the present embodiment, and FIG. 10 is a control block view of another example of a charging system according to the present embodiment.

A charger 1 of the other example of a charging system may comprise a plurality of charging cables 12a, 12b, 12c and 12d, and each of a cooling fluid inlet channel 4 and a cooling fluid outlet channel 5 may be connected to each of the plurality of charging cables 12a, 12b, 12c and 12d.

The charger 1 may comprise a power unit disposed in the charging cable unit 11, and the charging cable unit 11 or the connector 13 may comprise a switch that controls the current applied to the electric vehicle.

The charger 1 may comprise a plurality of switches, and may independently apply current to each of the plurality of charging cables 12a, 12b, 12c and 12d by controlling the plurality of switches.

If the charger 1 comprises a plurality of charging cables 12a, 12b, 12c and 12d, the valve 8 may be provided for each charging cable 12a, 12b, 12c and 12d. The charging system of the present embodiment may comprise a plurality of valves 86, 87, 88 and 89.

The controller 9″ may control the plurality of valves 86, 87, 88 and 89 according to the charging information of the plurality of charging cables 12a, 12b, 12c and 12d.

The cooler 3 and 3′ may be the same as or similar to the cooler 3 of the charging system, and may be the same as or similar to the cooler 3′ of another example of the charging system.

An example of the cooler 3 and 3′ may comprise a radiator 6, a pump 7, and a heat dissipation fan 62, like the cooler 3 of the charging system.

The other example of the cooler 3 and 3′ may comprise a pump 7, a compressor 31, a condenser 32, an expansion device 33, an evaporator 34, and a condensation fan 37, like the cooler 3′ of the other example of the charging system.

The cooling fluid inlet channel 4 may has a common inlet channel, a branch inlet channel branched from a common inlet channel and connected to each of a plurality of charging cables 12a, 12b, 12c and 12d.

The common inlet channel may be connected to a coolant path formed in a radiator 6 of an example of a charging system. The common inlet channel may be connected to a coolant path 36 formed in an evaporator 34 of another example of a charging system.

The branch inlet channels may be provided in 1:1 correspondence with the charging cables 12a, 12b, 12c and 12d.

The pump 7 may be installed in the common inlet channel, and the valve may be installed in each of the plurality of branch inlet channels.

The cooling fluid outlet channel 5 may comprise a common outlet channel and a combined outlet channel merged to the common outlet channel and connected to each of the plurality of charging cables 12a, 12b, 12c and 12d.

The common outlet channel may be connected to a charging system The common outlet channel may be connected to a coolant path formed in the radiator 6 of the example. The common outlet channel may be connected to a coolant path 36 formed in the evaporator 34 of the charging system of another example.

The combined outlet channel may be provided in 1:1 correspondence with the charging cables 12a, 12b, 12c and 12d.

The controller 9″ may receive charging information from the charger 1 and determine the cooling capacity of the cooler 3 or 3′ according to the received charging information.

The charging information received from the charger 1 may comprise charging information of each of the plurality of charging cables 12a, 12b, 12c and 12d.

The controller 9″ may vary the RPM of the heat dissipation fan 62 according to the charging information of the plurality of charging cables 12a, 12b, 12c and 12d.

The controller 9″ may adjust the rotation speed of the pump 7 in multiple stages according to the charging information of the plurality of charging cables 12a, 12b, 12c and 12d.

The controller 9″ may control the operating capacity of the compressor 31 in proportion to the charging voltage of the charging cable being charging among the plurality of charging cables 12a, 12b, 12c and 12d.

The controller 9″ may control the RPM of the condensing fan 37 in proportion to the charging voltage of the charging cable being charged among the plurality of charging cables 12a, 12b, 12c and 12d.

Without being limited to the above embodiments of the present invention, the cooler comprises a compressor, a condenser, and an expansion mechanism, the cooling fluid inlet channel 4 is connected to the plurality of charging cables, the cooling fluid inlet channel 4 is connected to the plurality of charging cables, and the refrigerant may be evaporated while passing through the plurality of charging cables, and the valve 8 may be provided for each of the plurality of charging cables.

The above description is merely an illustrative explanation of the technical idea of the present disclosure, and various modifications and variations will be possible to those skilled in the art without departing from the essential characteristics of the present disclosure.

Accordingly, the embodiments disclosed in the present disclosure are not intended to limit the technical idea of the present disclosure, but rather to explain it, and the scope of the technical idea of the present disclosure is not limited by these embodiments.

The scope of protection of the present disclosure should be interpreted in accordance with the claims below, and all technical ideas within the equivalent scope should be construed as being comprised in the scope of rights of the present disclosure.

1-19. (canceled)

20. A charging system comprising:
a plurality of chargers connected to charging cables having cable path formed inside of the charging cable;
a cooler for cooling a cooling fluid;
a cooling fluid inlet channel connected to the cooler and the plurality of charging cables and guiding the cooling fluid to the plurality of charging cables;
a cooling fluid outlet channel connected to the plurality of charging cables and the cooler and guiding the cooling fluid to the cooler;
a plurality of valves installed in at least one of the cooling fluid inlet channel and the cooling fluid outlet channel; and
a controller configured to control the plurality of valves according to charging information of the plurality of chargers,
wherein the cooling fluid is a coolant,
wherein the cooler further comprises:
a radiator that radiates the coolant; and
a pump that pumps the coolant, and
wherein the controller is configured to adjust a rotation speed of the pump in multiple stages according to the charging information of the plurality of chargers.

21. The charging system of claim 20, wherein the controller receives charging information from the plurality of chargers and determines a cooling capacity of the cooler according to a received charging information.

22. The charging system of claim 20, wherein the valve is an on-off valve,
wherein the controller is configured to control opening and closing of the on-off valve.

23. The charging system of claim 20, wherein the valve is a flow control valve,
wherein the controller is configured to control a flow rate of the flow control valve.

24. The charging system of claim 20, further comprises a heat dissipation fan blowing air to the radiator,
wherein the controller is configured to vary an RPM of the heat dissipation fan according to the charging information of the plurality of chargers.

25. A charging system comprising:
a charger having a plurality of charging cables connected to the charger, each of the plurality of charging cables having a cable path formed inside the charging cable;
a cooler for cooling a cooling fluid;
a cooling fluid inlet channel connected to the cooler and the plurality of charging cables and guiding the cooling fluid to the plurality of charging cables;
a cooling fluid outlet channel connected to the plurality of charging cables and the cooler and guiding the cooling fluid to the cooler;
a plurality of valves installed in at least one of the cooling fluid inlet channel and the cooling fluid outlet channel; and
a controller configured to control the plurality of valves according to charging information of the plurality of charging cables,
wherein the cooling fluid is a coolant,
wherein the cooler comprises a compressor, a condenser, an expansion device, and an evaporator through which refrigerant circulates,
wherein the evaporator has a refrigerant path through which the refrigerant passes, and a coolant path through which the coolant that exchanges heat with the refrigerant passes,
wherein each of the cooling fluid inlet channel and the cooling fluid outlet channel is connected to the coolant path,
wherein a pump pumping the coolant is installed in at least one of the cooling fluid inlet channel and the cooling fluid outlet channel, and
wherein the controller is configured to control an operating capacity of the compressor in proportion to a charging voltage of a charging cable being charging among the plurality of charging cables.

26. The charging system of claim 25, wherein the controller receives charging information from the charger and determines a cooling capacity of the cooler according to a received charging information.

27. The charging system of claim 25, wherein the cooler further comprises a condensing fan blowing air to the condenser, and
wherein the controller is configured to control an RPM of the condensing fan in proportion to a charging voltage of a charging cable being charging among the plurality of charging cables.

28. The charging system of claim 20, wherein the charging cable comprises:
a communication line;
a charging line having an inner channel formed inside that communicates with the cooling fluid inlet channel; and
an outer tube surrounding the charging line and the communication line, and
wherein an outer channel is formed between the charging line, the communication line, and the outer tube that communicates with the cooling fluid outlet channel.

29. The charging system of claim 25, wherein the charging cable comprises:
a communication line;
a charging line having an inner channel formed inside that communicates with the cooling fluid inlet channel; and
an outer tube surrounding the charging line and the communication line, and
wherein an outer channel is formed between the charging line, the communication line, and the outer tube that communicates with the cooling fluid outlet channel.
